(19) United States
(12) Patent Application Publication
(10) Pub. No.: US 2018/0186030 A1
(43) Pub. Date: Jul. 5, 2018

(54) TREATED POROUS MATERIAL

(71) Applicants: Dow Global Technologies LLC, Midland, MI (US); Rohm and Haas Company, Collegeville, PA (US)

(72) Inventors: Xue Chen, Manvel, TX (US); Zhenwen Fu, Norristown, PA (US); Stephen W. King, League City, TX (US); John Klier, Leverett, MA (US)

(21) Appl. No.: 15/740,532

(22) PCT Filed: Jun. 17, 2016
(86) PCT No.: PCT/US2016/038126

§ 371 Date: Dec. 28, 2017

Related U.S. Application Data
(60) Provisional application No. 62/186,584, filed on Jun. 30, 2015.

(51) Int. Cl. B27K 3/15; C08H 8/00

(52) U.S. Cl. CPC B27K 3/15; C08K 5/17; B27K 2240/70; C08H 8/00

(57) ABSTRACT

The present disclosure describes a treated cellulosic material comprising a cellulosic material having a porous structure defining a plurality of pores, at least a portion of the pores containing a treating agent comprising a reaction product of an epoxy resin, an acrylic latex and a carboxylated curing agent and/or amine curing agent. The present disclosure further describes a method for preparing a treated cellulosic material comprising providing a cellulosic material; and a first treatment protocol comprising impregnating the cellulosic material with an aqueous dispersion, the aqueous dispersion comprising an epoxy resin and an acrylic latex.

### BACKGROUND OF THE INVENTION

Porous materials, such as cellulosic materials, need to be protected from mold growth, insect attack, rot and water impregnation to help preserve the physical properties of the cellulosic material. One example of such a cellulosic material is wood. A variety of treatment agents and preservation methods are known to preserve cellulosic materials.

Modern preservation methods typically involve pressure treating the cellulosic material with a treating agent. Pressure treatment typically allows the treating agent to penetrate throughout the porous structure of the cellulosic material. The treating agent is typically a chemical compound selected to impart the desired physical properties to the cellulosic material. For example, treating agents that add water resistance and improve the dimensional stability of the cellulosic material are of interest. Wood is capable of absorbing as much as 100% of its weight in water which causes the wood to swell, which after loss of water through evaporation causes the wood to shrink. This process of water absorption/evaporation is non-uniform and creates internal stresses in the wood leading to splitting, warping, bowing, crooking, twisting, cupping, etc. Also, water can serve as a pathway for organisms that degrade the cellulosic material, such as insects or fungus.

Termites are one of the most significant insect groups responsible for wood damage. In order to mitigate termite damage, the use of naturally durable wood species, preservative treatments, and engineered wood products have been employed. However, the need for improved technologies for termite resistance are desirable due to the limited availability of durable woods, the high percentage weight gains required for preservatives to provide efficacy, and the “unnatural” look of engineered wood. A technology which is provides termite resistance and dimensional stability to wood is highly desirable.

Treating agents that repel insects, or minimize the formation of fungi/molds, or improve the overall durability of the cellulosic material are of interest. Further, treating agents can improve wind resistance, ultraviolet radiation resistance, stability at high and low temperatures, pest resistance, mold resistance, fire resistance and other issues which might affect the physical properties of the cellulosic material.

An improved treating agent for cellulosic materials is desired.

### SUMMARY OF THE INVENTION

In one instance, the present disclosure describes a treated cellulosic material comprising a cellulosic material having a porous structure defining a plurality of pores, at least a portion of the pores containing a treating agent comprising a reaction product of an epoxy resin, an acrylic latex and a carboxylated curing agent and/or amine curing agent.

In one instance, the present disclosure further describes a method for preparing a treated cellulosic material comprising providing a cellulosic material; and a first treatment protocol comprising impregnating the cellulosic material with an aqueous dispersion, the aqueous dispersion comprising an epoxy resin and an acrylic latex.

### DETAILED DESCRIPTION OF THE INVENTION

As used herein, the term “porous material” refers to a material which is permeable such that fluids are movable therethrough by way of pores or other passages. Examples of porous materials include cellulosic material, stone, concrete, ceramics, and derivatives thereof. As used herein, the term “cellulosic material” refers to a material that includes cellulose as a structural component. Examples of cellulosic materials include wood, paper, textiles, rope, particleboard and other biologic and synthetic materials. As used herein, the term “wood” includes solid wood and all wood composite materials, e.g., chipboard, engineered wood products, etc. Cellulosic materials generally have a porous structure that defines a plurality of pores.

A “treated cellulosic material” is a cellulosic material that has been treated with a treating agent to modify the properties of the cellulosic material. The properties modified by the treating agent may include, but are not limited to, increased hydrophobicity, dimensional stability, fungi resistance, mold resistance, insect resistance, hardness, surface appearance, UV stability, fire resistance, and coatability. Increasing the hydrophobicity of a cellulosic material can provide other ancillary benefits by reducing the rate of water adsorption and evaporation, thus reducing the internal stresses of expanding and contracting.

A “treating agent” is a substance that, when combined with the cellulosic material, modifies the properties of the cellulosic material. In one instance, the treating agent comprises the reaction product of an epoxy resin, an acrylic latex and a carboxylated curing agent and/or amine curing agent. The epoxy resin, acrylic latex and carboxylated curing agent and/or amine curing agent are collectively referred to as the “precursor to the treating agent.” The precursor to the treating agent is introduced to the cellulosic material. In one instance, the precursor to the treating agent is introduced to the cellulosic material in one or more dispersion. One method of applying the dispersion to the cellulosic material is through impregnation using pressure treatment. Other methods of applying the dispersion are known, such as brushing, coating, spraying, dipping, soaking and extrusion. Once applied, the dispersion will permeate at least a portion of the pores of the cellulosic material.

In one instance, the epoxy resin comprises a diglycidyl ether of bisphenol A, the diglycidyl ether of bisphenol F, 1,4-butanediol diglycidyl ether, 1,6-hexanediol diglycidyl ether, a diglycidyl ester of phthalic acid, 1,4-cyclohexanedmethanol diglycidyl ether, 1,3-cyclohexanedmethanol diglycidyl ether, a diglycidyl ester of hexahydrophthalic acid, a novolac resin, or a combination thereof. In one instance, the acrylic latex is prepared from a (meth)acrylate monomer. As used herein, the phrase “(meth)acrylate” means acrylate, methacrylate, and the mixture thereof. In one instance, the (meth)acrylate monomer comprises methyl acrylate, ethyl acrylate, butyl acrylate, 2-ethylhexyl acrylate, methyl methacrylate, ethyl methacrylate, butyl methacrylate, and 2-ethylhexyl methacrylate, phosphoethy methacrylate and combinations thereof. In one instance, the acrylic latex comprises a copolymer wherein one of the monomers is hydrophobic. In one instance, the acrylic latex comprises a copolymer wherein one of the monomers is hydrophilic. In one instance, the acrylic latex comprises a copolymer containing one or more hydrophobic monomers and one or more hydrophilic monomers. In one instance the hydrophobic monomer is a (meth)acrylate monomer, for example, butyl acrylate, 2-ethylhexyl acrylate, or butyl methacrylate. In one instance the hydrophobic monomer is a styrene monomer. In one instance the hydrophilic monomer is a (meth)acrylic acid monomer. In one instance the acrylic latex comprises a (meth)acrylic acid/styrene copolymer. In one instance, the acrylic latex comprises a (meth)acrylic acid/(meth)acrylate copolymer. In one instance the acrylic latex comprises a (meth)acrylate/styrene/(meth)acrylic acid copolymer. In one instance the copolymer comprises 10 weight percent or more of acrylic acid. In one instance the acrylic latex is formed from one or more monomers which are derivatives of acrylic acid. In one instance the acrylic latex is formed from one or more monomers which are derivatives of styrene. Examples of styrene and styrene derivative monomers suitable for use in the poly(meth)acrylate/styrene copolymer include 2-methylstyrene, 4-methylstyrene, 4-t-butylstyrene, divinyl benzene, styrene, 4-t-butoxystyrene, 4-nitrostyrene, and 4-vinylbenzoic acid. In one instance, the acrylic latex is further characterized by containing anti-agglomerating functional groups, which refer to hydrophilic groups that are sufficiently unreactive with the oxirane groups (and ester groups, if present) such that the latex particles are heat-age stable at 60° C. for 10 days. The term “heat-age stable at 60° C. for 10 days” is used herein to mean that the particle size of a latex subjected to heat-aging at 60° C. for 10 days stability does not increase by more than 30% beyond the particle size before such heat-age studies. Anti-agglomerating functional groups can be incorporated into the acrylic latex using monomers containing anti-agglomerating functional groups (anti-agglomerating monomers), although it would also be possible to incorporate such groups by grafting. The anti-agglomerating groups are believed to be effective because they are hydrophilic as well as non-reactive with oxirane groups under heat-age conditions. The general class of such groups includes amide groups, acetoacetoxy groups, and strong protic acids, which are pH adjusted to form their conjugate bases. In one instance, the anti-agglomerating functional groups are functional groups of acrylamide; acetoacetoxyethyl methacrylate; acetoacetoxyethyl methacrylate enamine; sodium p-styrene sulfonate; 2-acrylamido-2-methylpropane sulfonic acid or a salt thereof; or phosphoethymethacrylate or a salt thereof, or a combination thereof.

In one instance, the epoxy resin and acrylic latex are provided as an acrylic epoxy hybrid (AEH) aqueous dispersion. For example, Maincote™ AEH-10, available from The Dow Chemical Company, is a hybrid water dispersion of a Styrene Acrylic Latex with 30% Bisphenol A epoxy resins. In one instance, the AEH is a dispersion containing 40-60 percent solids. In one instance, 30 to 40 percent of the solids of the AEH comprise epoxy resin. In one instance, 60 to 70 percent of the solids of the AEH comprise acrylic latex.

In one instance, the carboxylated curing agent is a neutralized olefin-carboxylic acid copolymer which is the reaction product of an olefin-carboxylic acid copolymer and ammonia, an amine or a base. In one instance, the olefin-carboxylic acid copolymer comprises a monomer selected from the group comprising ethylene, propylene, 1-butene, 3-methyl-1-butene, 4-methyl-1-pentene, 3-methyl-1-pentene, 1-heptene, 1-hexene, 1-octene, 1-decene, 1-dodecene, butadiene, styrene, (meth)acrylic acid, maleic acid, maleic anhydride, or a mixture thereof. In one instance, a styrene acrylic acid dispersion is suitable, for example, Orotan™ CA-2005, commercially available from The Dow Chemical Company. As used herein, a polar olefin polymer is an olefin (co)polymer which contains one or more polar groups. In exemplary embodiments, the polymer may, for example, comprise one or more polar polyolefins, having a polar group as either a comonomer or grafted monomer. Examples of polar groups include carboxylic acids, carboxylic acid anhydrides, carboxylic acid esters, carboxylic acid salts, and carboxylic acid amides. In certain embodiments the polar olefin polymer is an olefin-carboxylic acid copolymer. Exemplary polar polyolefins include, but are not limited to, ethylene/acrylic acid (EAA) and ethylene/methacrylic acid (EMAA) copolymers, such as those available under the trademarks PRIMACOR™, commercially available from The Dow Chemical Company, NUCREL™, commercially available from E.I. DuPont de Nemours, and ESCOR™ commercially available from ExxonMobil Chemical Company. Exemplary copolymers also include ethylene/maleic anhydride copolymer, such as those available from The Dow Chemical Company under the trademark AMPLIFY™ GR. Exemplary copolymers further include ethylene/maleic anhydride and propylene/maleic anhydride copolymers, such as those available from Clariant International Ltd. under the trademark LICOCENE™. Other exemplary olefin-carboxylic acid copolymer include, but are not limited to, ethylene/vinyl acetate copolymer, ethylene/ethyl acrylate (EEA) copolymer, ethylene/methyl methacrylate (EMMA) copolymer, and ethylene butyl acrylate (EBA) copolymer. Other olefin-carboxylic acid copolymers may also be used. Copolymers which have ester or anhydride functionalities can be converted to carboxylic acids. Those having ordinary skill in the art will recognize that a number of other useful olefin-carboxylic acid copolymers may also be used. In one embodiment, the polar olefin polymer may, for example, comprise a polar polyolefin selected from the group consisting of ethylene/acrylic acid (EAA) copolymer, ethylene/methacrylic acid copolymer (EMAA), and combinations thereof. In one instance, the olefin-carboxylic acid copolymer comprises ethylene/(meth)acrylic acid copolymer either alone, or in a mixture with other polymers or copolymers. The carboxylic acid portion of the polymer is neutralized with a neutralizing agent at least in part to form a stable aqueous dispersion. As used herein, a neutralizing agent is any material in which the reaction with the carboxylic acid can potentially result in the formation of a salt. In one instance the neutralizing agent is selected from the hydroxides of alkali metals, ammonia or organic derivatives thereof (including amines). In one instance the neutralizing agent is a strong base or a weak base. For example, the neutralizing agent may be sodium hydroxide, potassium hydroxide, or ammonia or an amine, such as monoethanolamine (MEA), triethanolamine (TEA), diethylethanolamine (DEEA) or dimethylaminoethanol (DMEA). AQUACER™ 8804, available from BYK USA Inc., is an example of a neutralized EAA dispersion. A stable dispersion is a dispersion that is suitable for penetrating the pores of the cellulosic material. The neutralizing agent neutralizes at least a portion of the carboxylic acid groups of the polymer. As used herein, neutralization of the carboxylic acid groups refers to any reaction in which the hydrogen of the carboxylic acid group is transferred. In one instance, 5 to 100 mole percent of the carboxylic acid groups of the polymer are neutralized by the neutralizing agent. In another instance 10 to 80 mole percent of the carboxylic acid groups are neutralized by the neutralizing agent. In still another instance 20 to 70 mole percent of the carboxylic acid groups are neutralized by the neutralizing agent.

As stated above, the precursor to the treating agent is introduced to the cellulosic material in one or more dispersions. The dispersion(s) are preferably aqueous dispersion(s). In one instance, the treated cellulosic material is treated with a first treatment protocol comprising impregnating the cellulosic material with an aqueous dispersion, the aqueous dispersion comprises the epoxy resin and the acrylic latex. In one instance, the treated cellulosic material is treated with a second treatment protocol comprising impregnating the cellulosic material with a modifying agent, the modifying agent comprising the carboxylated curing agent and/or amine curing agent, as described in greater detail below. The aqueous dispersion is preferably a stable dispersion. A stable dispersion is a dispersion that, once formed, resists change in its properties over time and is therefore suitable for penetrating the pores of the cellulosic material. In one instance, the dispersion is substantially solvent-free, for example, having less than 1% by volume solvent. In one instance the aqueous dispersion has less than 0.1% by volume solvent. In one instance, the dispersion is solvent-free.

The dispersion(s) are prepared such that the suspended particle size in the dispersion is suitable for penetrating the pores of the cellulosic material for distribution through the cellulosic material. In one instance, the dispersion also comprises one or more additives. In one instance, any solids present in the stable aqueous dispersion are held in a stable suspension and are transportable by the dispersion into the pores of the cellulosic material. In one instance, the solids content of the dispersion is 1 to 75 weight percent.

The “modifying agent” is a substance that, when combined with the epoxy resin, polymerizes and/or crosslinks and/or cures at least a portion of the epoxy resin. As used herein, the modifying agent is an element of the precursor to the treating agent, though, as is described herein, in one instance the modifying agent is introduced to the cellulosic material in a separate treatment protocol than the balance of elements of the precursor to the treating agent. The modifying agent is preferably an agent which is known to cure and/or crosslink epoxy resins. In one instance, the modifying agent is a carboxylated curing agent. In one instance, the modifying agent is an amine curing agent. In one instance, the modifying agent is a curing hardener. In one instance, the modifying agent is a neutralized olefin-carboxylic acid copolymer which is the reaction product of an olefin-carboxylic acid copolymer and ammonia, an amine or a base. The neutralized olefin-carboxylic acid copolymer is as described herein. Examples of the amine curing agents include the amine curing agent comprises diethylenetriamine, triethylenetetramine, tetraethylene-pentamine, 2,2,4-trimethylhexamethylenediamine, 2,4,4-trimethylhexamethylene-diamine, 1,6-hexanediamine, 1-ethyl-1,3-propanediamine, bis(3-aminopropyl)piperazine, N-aminoethylpiperazine, N,N-bis(3-aminopropyl)ethylenediamine, 2,4toluenediamine, 2,6-toluene-diamine, 1,2diaminocyclohexane, 1,4-diamino-3,6-diethylcyclohexane, 1,2-diamino-4-ethyl-cyclohexane, 1,4-diamino-3,6-diethylcyclohexane, 1-cyclohexyl-3,4-diaminocyclohexane, isophoronediamine, norboranediamine, 4,4′-diaminodicyclohexylmethane, 4,4′-diamino-dicyclohexylmethane, 4,4′diaminodicyclohexyl-propane, 2,2-bis(4-aminocyclohexyl)propane, 3,3′-dimethyl-4,4′-diaminodicyclohexylmethane, 3-amino-1-cyclohexane-amino-propane, 1,3- and 1,4-bis(aminomethyl)cyclohexane, m-xylylenediamine, p-xylylenediamine, polyoxypropylenediamines, polyamidoamines, and polyethyleneimines (PEI).

The treating agent is combined with the cellulosic material. In one instance, the precursor to the treating agent is introduced to the cellulosic material by pressure treatment, as described herein. In another instance, the precursor to the treating agent is introduced to the cellulosic material by other techniques known in the art, for example, brushing, coating, dipping, soaking, spraying, and extrusion. The precursor to the treating agent becomes impregnated in at least a portion of the pores of the cellulosic material, and thereby increases the weight of the cellulosic material. Without being limited by theory, it is expected that the precursor to the treating agent reacts when impregnated in the cellulosic material to form the treating agent. In one instance, the treating agent increases the weight of the cellulosic material by 1 to 80 percent (as compared to the original weight of the cellulosic material and as calculated after drying the cellulosic material for at least 2 hours at or above 60° C.). In one instance, the treating agent increases the weight of the cellulosic material by 5 to greater than 100 percent (as calculated after drying the cellulosic material for at least 2 hours at or above 60° C.).

In one instance, one or more additives are impregnated in the cellulosic material. The additive may be introduced as part of the dispersion, as part of the modifying agent, or may be introduced separately therefrom. Additives which are known to add properties to treated cellulosic materials are suitable, such as, flame retardants, dispersants and/or dyes. The additives may also include nanofillers which are known to be compatible with epoxy dispersions. For example, the additives may be organic compounds, metallic compounds, or organometallic compounds. In one instance, the additive is a material which improves the wetting or penetration of the dispersion into the wood, for example, solvents or surfactants (anionic, cationic or nonionic) that are stable in the dispersion. Examples of additives include solvents, fillers, thickeners, emulsifiers, dispersing agents, buffers, pigments, penetrants, antistatic agents, odor substances, corrosion inhibitors, preservatives, siliconizing agents, rheology modifiers, anti-settling agents, anti-oxidants, other crosslinkers (e.g. diols and polyols), optical brighteners, waxes, coalescence agents, biocides and anti-foaming agents. Such waxes may include petroleum waxes, paraffin waxes, a natural wax, or a synthetic wax such as polyethylene wax or oxidized polyethylene wax, beeswax, or slack wax. In addition, the additive may be a wood preservative containing, for example, cupric-ammonia, cupric-amine, cupric-ammonia-amine complexes, quaternary ammonium compounds, or other systems. For example, Alkaline Copper-Quaternary ammonium (ACQ) preservative systems. The additive may include wood preservative technologies which use zinc salts or boron containing compounds. Optionally, other additives such as insecticides, termiticides, fungicides, and moldicides may be added to the cellulosic material. In one instance, the additive is included as part of the dispersion and forms a stable suspension therewith. In one instance, one or more surfactant is added to the dispersion. In one instance, a surfactant is selected which increases the amount of dispersion impregnated in the cellulosic material. For example, suitable surfactants may be nonionic or anionic. Examples of nonionic surfactants include: alkoxylated alcohols, alkoxylated alkyl phenols, fatty acid esters, amine and amide derivatives, alkylpolyglucosides, ethylene oxide/propylene oxide copolymers, polyols, and alkoxylated polyols. For example, a nonionic surfactant is TERGITOL™ L-62, commercially available from The Dow Chemical Company. Examples of anionic surfactants include: alkyl sulfates, alkyether sulfates, sulfated alkanolamides, alpha olefin sulfonates, lignosulfonates, sulfosuccinates, fatty acid salts, and phosphate esters. For example, an anionic surfactant is DOWFAX™ C10L, commercially available from the Dow Chemical Company.

In one instance the dispersion constituents have a sufficiently small particle size to penetrate the pores of the cellulosic material. In one instance, the dispersion constituents have a particle size no greater than 50 μm. In one instance, the dispersion constituents have a particle size no greater than 5 μm. In one instance, the dispersion constituents have a particle size less than 0.5 μm.

In one instance, the cellulosic material is prepared as a treated cellulosic material by pressure treatment. The pressure used to pressure treat the cellulosic material may be either higher or lower than atmospheric pressure. In one instance, the pressure is lower than ambient pressure, for example, 0.0001 to 0.09 MPa (0.75 to 675 mmHg). In another instance, the pressure is greater than ambient pressure, for example, 0.1 to 1.7 MPa (750 to 12750 mmHg). It is envisioned that pressure treatment processes known in the art are suitable for impregnating the cellulosic material with the treating agent.

As described above, in one instance, the treated cellulosic material is prepared according to at least a first treatment protocol and a second treatment protocol. In one instance, the first treatment protocol comprises impregnating the cellulosic material with the dispersion comprising the epoxy resin and the acrylic latex. The first treatment protocol comprises one or more of the following steps: (a) depositing the cellulosic material in a vessel; (b) holding the vessel at vacuum for 5 to 60 minutes; (c) introducing an aqueous dispersion comprising the epoxy resin and the acrylic latex to the vessel; (d) pressurizing the vessel to 1.03 MPa for 5 to 60 minutes; (e) draining the excess aqueous dispersion; (f) optionally removing excess aqueous dispersion by vacuum; and (g) air drying the cellulosic material at 20 to 60° C. for 24 to 48 hours. In one instance, the product of the first treatment protocol is prepared according to a second treatment protocol that impregnates the cellulosic material with the modifying agent. The second treatment protocol comprises one or more of the following steps: (a) depositing the cellulosic material prepared according to the first treatment protocol in a vessel; (b) introducing the modifying agent to the vessel; (c) holding the vessel at either vacuum or increased pressure for 5 to 60 minutes; (d) optionally removing excess modifying agent by vacuum; and (e) air drying the cellulosic material at 60° C. for 24 to 48 hours.

The designations “first treatment protocol” and “second treatment protocol” are not meant to be read as defining a treatment order. It is envisioned that the cellulosic material may be treated first with the dispersion and second treated with the modifying agent, whereby the second treatment follows the first treatment in time. It is also envisioned that the cellulosic material may be treated first with the modifying agent and second treated with the dispersion, whereby the second treatment protocol precedes the first treatment protocol in time. It is also envisioned that the cellulosic material may be treated simultaneously with the first treatment protocol and the second treatment protocol (in which case the cellulosic material should be treated promptly after combining the dispersion and the modifying agent to minimize the curing reaction).

The several drying steps may be performed at a range of temperatures, whereby the duration of the drying step is proportional to the temperature. Suitable drying temperatures are between room temperature (roughly 20° C.) and 180° C. The drying may be performed in air, in nitrogen, or other suitable atmosphere.

In one instance, the second treatment protocol comprises a heating protocol, where the product of the first treatment protocol is heated in air at 80° C. for 1 to 7 days. Without being limited by theory, it is expected that the combination of high temperatures and the natural components of the porous material encourage the epoxy to polymerize and crosslink.

A water immersion test is used to determine the water repellency of the treated cellulosic material according to the American Wood Protection Association Standard E4-11 procedure (Standard Method of Testing Water Repellency of Pressure Treated Wood). The water immersion test involves first, providing both a treated wafer, comprising a treated cellulosic material prepared as described herein, and a control wafer, comprising an untreated cellulosic material; second, measuring the tangential dimension of both the treated wafer and the control wafer to provide an initial tangential dimension (T₁) (where the tangential dimension is perpendicular to the direction of the grain of the cellulosic material); third, placing both the treated wafer and the control wafer in a conditioning chamber maintained at 65±3% relative humidity and 21±3° C. until a constant weight is achieved; fourth, immersing both the treated wafer and the control wafer in distilled water at 24±3° C. for 30 minutes; and fourth, measuring the tangential dimension of both the treated wafer and the control wafer following removal from the water to provide a post tangential dimension (T₂).

The percent swelling (S) for each individual wafer (both the treated wafer and the control wafer) is calculated as:

$$S ( \% ) = \frac{{T}_{2} - {T}_{1}}{{T}_{1}} \times 100$$

In each of the Examples herein, the percent swelling of the control wafer is 4.7%.

Water-repellency efficiency (WRE) is used to determine the effectiveness of the treating agent in adding water repellant properties to the treated cellulosic material. WRE is calculated as:

$$WRE ( \% ) = \frac{{S}_{1} - {S}_{2}}{{S}_{1}} \times 100$$

S₁ refers to the percent swelling of the untreated wafer; S₂ refers to the percent swelling of the treated wafer. According to E4-11, for most outdoor applications a minimum WRE of 75% is preferred. The WRE of the control wafer is 0%.

The hardness of the treated cellulosic material is determined according to the Shore (Durometer) test using a Type D Durometer (30° cone, 1.40 mm diameter, 2.54 mm extension, 44.48N spring force). Hardness is determined using the Type D Durometer by placing the cellulosic material on a hard flat surface, and the foot of the durometer is pressed with the given spring force against the cellulosic material. The hardness value is recorded from the gauge on the Durometer within one second of contact with the cellulosic material. At least five hardness tests were performed per sample of cellulosic material. Hardness values reported herein are averages of the tests performed for a given cellulosic material. The hardness value of an untreated southern yellow pine control wafer is approximately 40.

The following Examples illustrate certain aspects of the present disclosure, but the scope of the present disclosure is not limited to the following Examples.

Five pine wafers (identified as A, B, C, D and E) (southern yellow pine, 4 cm×2 cm×0.5 cm) are each held at the bottom of a Parr reactor by a weight (here a ring is used). The reactor pressure is set to vacuum for 30 minutes. 80 ml of, Maincote™ AEH-10 aqueous dispersion (available from The Dow Chemical Company) that is diluted to 30% solid concentration using water is introduced to each reactor. Each reactor pressure is then set to 1.03 MPa for 60 minutes under nitrogen. Each wafer is then placed in an oven and dried in air at 80° C. for the amount of time listed in Table 1.

TABLE 1

| Wafer | Oven Time |
|---|---|
| A | 6 days |
| B | 14 days |
| C | 3 days |
| D | 3 days |
| E | 3 days |

Wafers C, D and E are then returned to a reactor and held at the bottom by a weight. The reactor pressure is set to vacuum for 30 minutes. 80 ml of the agent listed in Table 2 is introduced to the respective reactor. Each reactor pressure is then set to 1.03 MPa for 60 minutes under nitrogen. Each wafer is then placed in an oven and dried in air at 60° C. for 2 days.

TABLE 2

| Wafer | Agent |
|---|---|
| C | 5% PEI solution in water |
| D | 20% Primacor ™ 5980i dispersion neutralized by 100% TEA |
| E | 20% Primacor ™ 5980i dispersion neutralized by 100% TEA |

Wafer E is then returned to a reactor and held at the bottom by a weight. The reactor pressure is set to vacuum for 30 minutes. 80 ml of 5% PEI solution in water is introduced to the reactor. The reactor pressure is then set to 1.03 MPa for 30 minutes under nitrogen. The wafer is then placed in an oven and dried in air at 60° C. for 2 days.

Each of the treated wafers and a control wafer are processed according to the E4-11 procedure and the percent swelling and the WRE of each wafer is listed in Table 3. The hardness of each treated wafer is measured using a Type D Durometer, with the value listed in Table 3.

TABLE 3

| Example | Percent Swelling | WRE | Hardness |
|---|---|---|---|
| Control | 100% | 0% | 40 |
| A | 1.7% | 46.40 | 51 |
| B | 2.4% | 18.82 | 44 |
| C | 0.27% | 91.11 | 52 |
| D | 0.57% | 81.11 | 58 |
| E | 0.45% | 85.69 | 58 |

The Examples illustrate that a cellulosic material containing the treating agent yields improved WRE, hardness and swelling as compared to the control. Additionally, the use of a modifying agent further improves the WRE and hardness compared to treatment with the acrylic epoxy hybrid (AEH) aqueous dispersion only.

1-9. (canceled)

10. A method for preparing a treated cellulosic material comprising:
providing a cellulosic material; and
a first treatment protocol comprising impregnating the cellulosic material with an aqueous dispersion, the aqueous dispersion comprising an epoxy resin and an acrylic latex, wherein the impregnation of the first treatment protocol is conducted under a pressure that is greater than or lower than ambient.

11. The method for preparing a treated cellulosic material of claim 10, further comprising:
a second treatment protocol comprising impregnating the cellulosic material with a modifying agent, the modifying agent comprising a carboxylated curing agent, or an amine curing agent.

12. (canceled)

13. The method of claim 10, wherein the epoxy resin comprises a diglycidyl ether of bisphenol A, the diglycidyl ether of bisphenol F, 1,4-butanediol diglycidyl ether, 1,6-hexanediol diglycidyl ether, a diglycidyl ester of phthalic acid, 1,4-cyclohexanedmethanol diglycidyl ether, 1,3-cyclohexanedmethanol diglycidyl ether, a diglycidyl ester of hexahydrophthalic acid, a novolac resin, or a combination thereof.

14. The method of claim 10, wherein the carboxylated curing agent is the reaction product of an olefin-carboxylic acid copolymer and ammonia, an amine or a base.

15. The method of claim 10, wherein the amine curing agent comprises diethylenetriamine, triethylenetetramine, tetraethylene-pentamine, 2,2,4-trimethylhexamethylenediamine, 2,4,4-trimethylhexamethylene-diamine, 1,6-hexanediamine, 1-ethyl-1,3-propanediamine, bis(3-aminopropyl)piperazine, N-aminoethylpiperazine, N,N-bis(3-aminopropyl)ethylenediamine, 2,4toluenediamine, 2,6-toluene-diamine, 1,2diaminocyclohexane, 1,4-diamino-3,6-diethylcyclohexane, 1,2-diamino-4-ethyl-cyclohexane, 1,4-diamino-3,6-diethylcyclohexane, 1-cyclohexyl-3,4-diaminocyclohexane, isophoronediamine, norboranediamine, 4,4′-diaminodicyclohexylmethane, 4,4′-diamino-dicyclohexylmethane, 4,4′diaminodicyclohexyl-propane, 2,2-bis(4-aminocyclohexyl)propane, 3,3′-dimethyl-4,4′-diaminodicyclohexylmethane, 3-amino-1-cyclohexane-amino-propane, 1,3- and 1,4-bis(aminomethyl)cyclohexane, m-xylylenediamine, p-xylylenediamine, polyoxypropylenediamines, polyamidoamines, or polyethyleneimines.

16. The method of claim 10, wherein the acrylic latex is prepared from a (meth)acrylate monomer or a (meth)acrylate comonomer.

17. The method of claim 16, wherein the (meth)acrylate monomer comprises methyl acrylate, ethyl acrylate, butyl acrylate, 2-ethylhexyl acrylate, methyl methacrylate, ethyl methacrylate, butyl methacrylate, and 2-ethylhexyl methacrylate, phosphoethy methacrylate and combinations thereof.

18. The treated cellulosic materials of claim 16, wherein the (meth)acrylate comonomer comprises a styrene monomer, a vinyl addition monomer or a combination thereof.
